(19) United States
(12) Patent Application Publication
(10) Pub. No.: US 2013/0321552 A1
(43) Pub. Date: Dec. 5, 2013

(54) SYSTEM AND METHOD FOR PROVIDING AND TRANSMITTING VIDEO IMAGES AND/OR AUDIO MESSAGES

(71) Applicant: Tim Goldburt, New York, NY (US)

(72) Inventor: Tim Goldburt, New York, NY (US)

(21) Appl. No.: 13/482,681

(22) Filed: May 29, 2012

(51) Int. Cl. H04N 7/14

(52) U.S. Cl. 348/14.02; 348/14.01; 348/E07.078

(57) ABSTRACT

A system for providing and monitoring video images and/or audio messages has an electronic device generating video images and/or audio messages; a container for beverages having an outer surface provided with a first recess; and an article wearable on a user's body and provided with a second recess, configured so that the electronic device is insertable into the first recess inserted and held on the beverage container and can be removed from the first recess and held in second recess of the wearable article, to allow providing and monitoring of the video images and/or audio messages either on the beverage container or on the wearable article.

### BACKGROUND OF THE INVENTION

The present invention relates to system and method for providing and transmitting video images and/or audio messages.

Systems and methods of the above mentioned type are known, and some of them are disclosed in our U.S. Pat. Nos. D617,200; 7,954,970; 8,056,273; 8,123,033 and patent application Ser. Nos. 11/588,494; 11/821,334; 11/821,349; 12/454,862; 12/454,863; 12/590,000; 12/590,013 and 12/655,418.

While the systems and methods disclosed in the above-identified documents include electronic devices providing video images and/or audio messages which can be received by the user, this is limited exclusively to the user's location in the vicinity of only one object which has one application. It would be very beneficial however if a user can see and hear the video images and/or audio messages at different locations, in association with different objects, etc.

### SUMMARY OF THE INVENTION

Accordingly, it is an object of the present invention to provide system and method for providing and transmitting video images and/or audio messages, which is a further improvement of existing systems and methods of this type.

In keeping with these objects and with others one feature of the present invention resides in a system for providing and transmitting video electronically produced images and/or audio messages, comprising an electronic device including means for generating video images and/or audio messages; a container for beverages having an interior for accommodating a beverage and an outer surface provided with a first recess; and a decorative article wearable on a user's body and provided with a second recess, said electronic device and said first and second recesses being configured so that said electronic device is insertable into said first recess and held on said beverage container and also can be removed from said first recess, inserted into said second recess and held in said wearable article, to allow providing and transmitting of the video images and/or audio messages either when said electronic device is held in said beverage container or when said electronic device is held in said wearable article.

Another feature of the present invention resides in that said first recess extends inwardly from an outer surface of a substantially cylindrical body of said beverage container, inserted into said second recess said second recess extends inwardly from an outer surface of a substantially cylindrical body of said wearable article.

A further feature resides in that said electronic device has dimensions corresponding to dimensions of said first and second recesses such that said electronic device can be snap-fitted into one of said first and second recesses.

Still a further feature of the invention resides in that said beverage container has an interior accommodating a beverage selected from the group consisting of an alcoholic beverage or a non-alcoholic beverage, while wearable article has an inner surface fittable on a user.

Still another features of the present invention is that the video images and/or audio messages can be transmitted wirelessly.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an electronic device of the inventive system and method for providing and transmitting video images and audio messages;

FIGS. 2 and 3 are side and plan views showing a container for beverages with the electronic device of the inventive system and method for providing and transmitting video images and audio messages;

FIGS. 4 and 5 are views showing a user-wearable article with the electronic device of the inventive system and method for providing and transmitting video images and audio messages.

### DESCRIPTION OF THE PREFERRED EMBODIMENTS

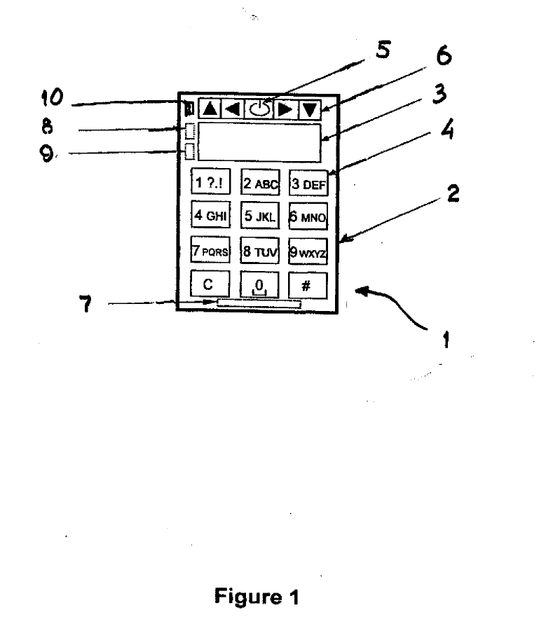

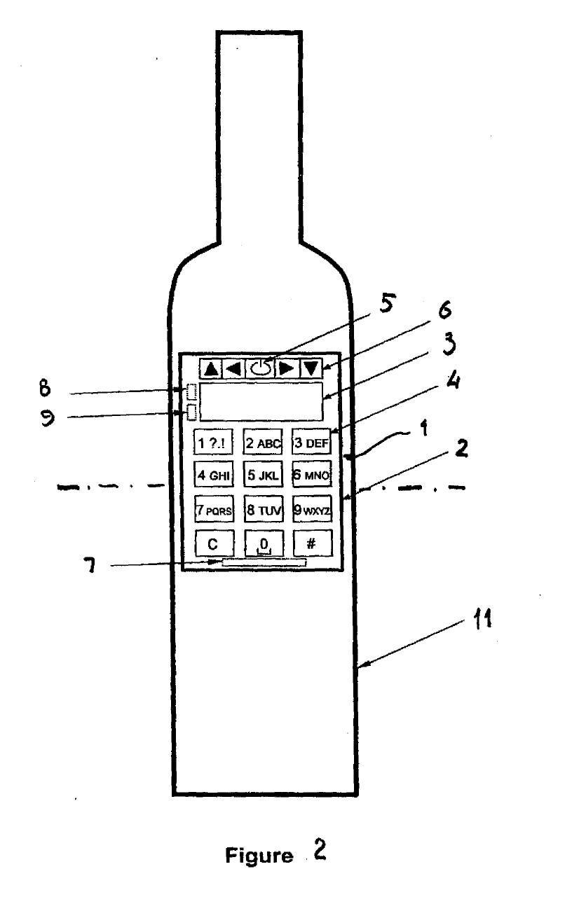

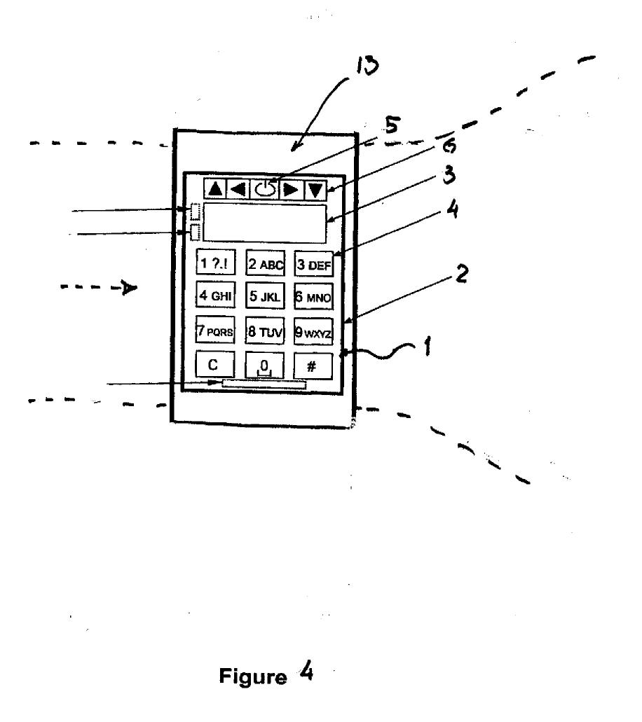

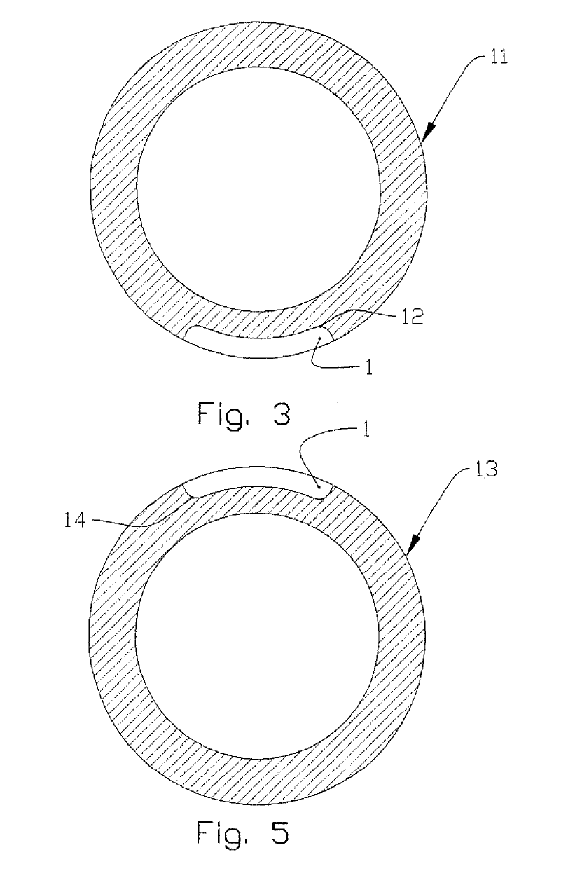

The system in accordance with the present invention has an electronic device shown in FIG. 1 and identified with reference numeral 1.

The electronic device has a housing 2. The electronic device includes an electronic display which can be formed as a conventional computer-type screen and identified with reference numeral 3. The electronic device further has user-operated control means formed for example as an alpha numerical keyboard 4 with a plurality of alpha numerical symbols. The electronic device also includes an on/off button 5 and control buttons 6 including up, left, right, and down buttons.

In order to operate the electronic device 2 to produce video images, a user turns the on/off button to the position on and operates the keys of the keyboard 4. As a result, a curser (arrow) appears on the display 3. With the use of the buttons 6, the user can move the curser to the desired location on the display or the desired image on the display.

The electronic device has also a battery 7, a microprocessor 8, and a memory 9 which can be built in the device 2, for example in an area behind the alpha numerical keyboard. The images to be displayed are stored in the memory and retrieved from it to be shown on the display.

The electronic device also has means for producing audio messages including for example an audio message generator with a speaker 10. The audio images and video messages can be generated separately or jointly.

The system in accordance with the present invention further has a container for alcoholic or non-alcoholic beverages, which is identified with reference numeral 11. The container 11 has a recess 12 provided in an outer surface of its cylindrical wall and extending radially inwardly over a part of its circumference.

The system further has an article wearable by a user, for example a wrist bracelet, which is identified with reference numeral 13. The article 13 has a recess 14 extending inwardly from its outer surface and extending at least over a part of length of its substantially cylindrical body.

The electronic device 1 and said first 12 and second 14 recesses are configured so that the electronic device is insertable into the first recess 12 and held on the beverage container 1 and also can be removed from the first recess, introduced into the second recess 14 and held in the wearable article 13 and vice versa. This allows providing and transmitting of the video images and/or audio messages and seeing and hearing them by a user either when the electronic device is held in the beverage container 1 or when the electronic device is held in the wearable article 13.

The electronic device 1 has dimensions (width, length, depth) corresponding to dimensions of the first 12 and second 14 recesses such that the electronic device 1 can be snap-fitted into each one of the first and second recesses.

The beverage container 11 has an interior accommodating a beverage selected from the group consisting of an alcoholic beverage or a non-alcoholic beverage. The wearable 13 article in particular the bracelet has an inner surface fittable on a wrist of a user.

When the system and method for monitoring video images and/or audio messages are provided in accordance with the present invention, they provide for totally new and exceptionally efficient possibilities for monitoring video images and/or audio messages. A user can see and hear the video images and/or audio messages when he or she is in a restaurant, a bar, in a party, in a social event, etc. when the electronic device of the invention is held on the beverage container, and also when he or she is travelling, stays in a vehicle, train, ship, airplane, is in school, college, on a meeting, a conference, etc. when the electronic device is held in his or her wearable article, such as for example a bracelet. Such possibilities of universal providing and transmitting of electronic video images and/or audio messages and seeing and hearing them in various locations, circumstances, conditions have never been achieved before.

It will be understood that each of the elements described above, or two or more together, may also find a useful application in other types of constructions and methods differing from the type described above.

While the invention has been illustrated and described as embodied in a system and method for monitoring video images and/or audio messages, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A system for providing and transmitting video images and/or audio messages, comprising an electronic device with means for generating video images and/or audio messages; a container for beverages having an interior for accommodating a beverage and an outer surface provided with a first recess; and a decorative article wearable on a user's body and provided with a second recess, said electronic device and said first and second recesses being configured so that said electronic device is insertable into said first recess and held on said beverage container and also removable from said first recess, insertable into said second recess and held in said wearable article, for providing and transmitting of the video images and/or audio messages by a user either when said electronic device is held in said beverage container or when said electronic device is held in said wearable article.

2. A system as defined in claim 1, wherein said first recess extends inwardly from an outer surface of a substantially cylindrical body of said beverage container.

3. A system as defined in claim 1, wherein said second recess extends inwardly from an outer surface of a substantially cylindrical body of said wearable article.

4. A system as defined in claim 1, wherein said electronic device has dimensions corresponding to dimensions of said first and second recesses such that said electronic device can be snap-fitted into each of said first and second recesses.

5. A system as defined in claim 1, wherein said beverage container has an interior accommodating a beverage selected from the group consisting of an alcoholic beverage or a non-alcoholic beverage.

6. A system as defined in claim 1, wherein said wearable article has an inner surface fittable on a user.

7. A system as defined in claim 1, further comprising means for providing and transmitting the video images and/or audio messages wirelessly.

8. A method for providing and transmitting video images and/or audio messages, comprising the steps of generating by an electronic device video images and/or audio messages; providing a container for beverages having an interior for accommodating a beverage and an outer surface provided with a first recess and a decorative article wearable on a user's body and provided with a second recess; inserting said electronic device into said first recess and holding it on said beverage container removing the electronic device from said first recess, inserting into said second recess, and holding in said wearable article and providing and transmitting the video images and/or audio messages by a user either when said electronic device is held in said beverage container or when said electronic device is held in said wearable article.

9. A method as defined in claim 8; further comprising extending said first recess inwardly from an outer surface of a substantially cylindrical body of said beverage container.

10. A method as defined in claim 8; further comprising extending said second recess inwardly from an outer surface of a substantially cylindrical body of said wearable article.

11. A method as defined in claim 8; further comprising providing in said electronic device dimensions and corresponding to dimensions of said first and second recesses; and snap-fitting said electronic device into each of said first and second recesses.

12. A method as defined in claim 8, further comprising providing said beverage container an interior; and accommodating in the interior a beverage selected from the group consisting of an alcoholic beverage or a non-alcoholic beverage.

13. A method as defined in claim 8, further comprising providing said wearable article with an inner surface fittable on a user.

14. A method as defined in claim 8, further comprising providing and transmitting the video images and/or the audio messages wirelessly.
